(19) United States
(12) Patent Application Publication
(10) Pub. No.: US 2024/0302490 A1
(43) Pub. Date: Sep. 12, 2024

(54) LOADED-TYPE SURVEYING SENSOR USING CNT OR CONDUCTIVE POLYMER AND METHOD FOR MANUFACTURING THE SAME

(71) Applicant: KOREA INSTITUTE OF GEOSCIENCE AND MINERAL RESOURCES, Daejeon (KR)

(72) Inventors: Woong KANG, Daejeon (KR); Kangwook KIM, Gwangju (KR)

(21) Appl. No.: 18/595,662

(22) Filed: Mar. 5, 2024

(30) Foreign Application Priority Data
Mar. 10, 2023 (KR) 10-2023-0031526

(51) Int. Cl. G01S 7/03; H01Q 1/38

(52) U.S. Cl. CPC G01S 7/03; H01Q 1/38

(57) ABSTRACT

An objective of the preset disclosure is to provide a loading-type surveying sensor using a CNT or a conductive polymer that implements a resistive antenna by spraying a carbon nanotube ink on a copper unclad substrate or implements a resistive antenna by using a conductive polymer, and a method of manufacturing the loading-type surveying sensor. In order to achieve the objective, a loading-type surveying sensor using a CNT or a conductive polymer according to the present disclosure includes: a copper unclad substrate; and a profile formed on the copper unclad substrate, in which a plurality of regions is formed with predetermined intervals for a sensor region to form the profile.

### CROSS REFERENCE TO RELATED APPLICATION

The present application claims priority to Korean Patent Applications No. 10-2023-0031526 filed on Mar. 10, 2023 the entire contents of which are incorporated herein for all purposes by this reference.

### BACKGROUND

### Technical Field

The present disclosure relates to a loading-type surveying sensor and a method of manufacturing the loading-type surveying sensor and, more specifically, to a loading-type surveying sensor using a CNT or a conductive polymer and a method of manufacturing the loading-type surveying sensor.

### Description of the Related Art

In general, a resistive antenna is an antenna that can be appropriately used as a short range radar sensor by equipping an antenna structure with a resistor.

As antennas that have been used for short range detection radars that detect objects using short pulses, there may be a Vivaldi antenna, an impulse radiating antenna, a TEM horn antenna, a resistive antenna, etc.

The resistive antenna of these antennas is an antenna loaded with a resistor in accordance with a certain profile for a certain position in the antenna and has the advantage that it enables high density arrangement due to a small volume and the advantage that it can copy an ultra-wideband signal with little distortion in a time domain, so it has been generally used for short range imaging radars.

As an existing method for implementing such a resistive antenna on a PCB, there is a method of discretizing a profile and then soldering a chip resistor to each of discretized sections. However, this technique has problems in terms of inconvenience in implementation using a plurality of resistors, limitation in high-power performance of chip resistors, limitation in high-frequency performance of chip resistors, physical stability such as damage to chip resistors and damage to soldered joints, etc.

Further, as a method of implementing a resistive antenna for solving this problem, there is a method of using a resistive pad.

This includes a plurality of segments disposed with predetermined intervals in the antenna structure of a PCB composed of a substrate, a resistive pad layer, and a metal layer and is formed by removing the metal layer disposed in the antenna structure through etching on the basis of the sizes of resistive pads corresponding to resistance values set in advance for the a plurality of segments, respectively.

Further, regions not corresponding to the antenna on the PCB are formed by removing the metal layer and the resistive pad layer both through etching.

When resistive pads are used for a resistive antenna, as described above, there is no influence by a high frequency, so it is possible to have the advantages that it is possible to implement an accurate and stable resistance profile even at a high frequency, implementation is simple in comparison to using chip resistors, and it is possible to exclude the possibility of damage that may be caused by limited operation frequency range and allowable power of chip resistors and the soldering method.

However, the chip resistor type or the resistive pad type described above both need etching of a predetermined antenna structure pattern on a copper clad substrate, so there is a problem that etching byproducts that are harmful to the environment are produced.

### PRIOR ART DOCUMENT

### Patent Document

(Patent Document 1) Korean Patent No. 10-1634565

### SUMMARY

In order to solve the problems of the related art described above, an objective of the present disclosure is to provide a loading-type surveying sensor using a CNT or a conductive polymer that implements a resistive antenna by spraying a carbon nanotube copper unclad substrate or implements a resistive antenna by using a conductive copolymer, and a method of manufacturing the loading-type surveying sensor.

In order to achieve the objectives, a loading-type surveying sensor using a CNT or a conductive polymer according to the present disclosure includes: a copper unclad substrate; and a conductive region and a resistive region formed on the copper unclad substrate, in which the conductive region and the resistive region are formed in a plurality of regions in accordance with predetermined shape and resistance value.

Further, in the loading-type surveying sensor according to the present disclosure, a resistive substance is formed in the resistive region.

Further, in the loading-type surveying sensor according to the present disclosure, the resistive substance is a carbon nanotube (CNT) ink or a conductive polymer.

Further, in the loading-type surveying sensor according to the present disclosure, the resistive substance is formed by a spray coating method.

Further, in the loading-type surveying sensor according to the present disclosure, a resistive substance is formed by a screen printing method.

Further, in the loading-type surveying sensor according to the present disclosure, a resistive substance is formed by an inkjet printing method.

Further, in the loading-type surveying sensor according to the present disclosure, a conductive substance is formed in the conductive region.

Further, in the loading-type surveying sensor according to the present disclosure, the conductive substance is a silver ink.

Further, in the loading-type surveying sensor according to the present disclosure, the conductive substance is formed by a screen printing method.

Further, in the loading-type surveying sensor according to the present disclosure, the conductive substance is formed by an inkjet printing method.

Further, in order to achieve the objectives, a method of manufacturing a loading-type surveying sensor according to the present disclosure includes: preparing a copper unclad substrate; dividing a sensor region into a plurality of regions with predetermined intervals on the copper unclad substrate; and implementing a profile by forming a resistance value for each of the plurality of separated regions.

Further, in the method of manufacturing a loading-type surveying sensor according to the present disclosure, a resistive substance is formed in the plurality of regions.

Further, in the method of manufacturing a loading-type surveying sensor according to the present disclosure, the resistive substance is a carbon nanotube (CNT) ink or a conductive polymer.

Further, in the method of manufacturing a loading-type surveying sensor according to the present disclosure, the resistive substance is formed by a spray coating method.

Further, in the method of manufacturing a loading-type surveying sensor according to the present disclosure, the resistive substance is formed by a screen printing method.

Further, in the method of manufacturing a loading-type surveying sensor according to the present disclosure, a conductive substance is formed between the plurality of regions.

Further, in the method of manufacturing a loading-type surveying sensor according to the present disclosure, the conductive substance is a silver ink.

Further, in the method of manufacturing a loading-type surveying sensor according to the present disclosure, the conductive substance is formed by a screen printing method.

Further, in the method of manufacturing a loading-type surveying sensor according to the present disclosure, the conductive substance is formed by an inkjet printing method.

Meanwhile, in order to achieve the objectives, the loading-type surveying sensor to the present disclosure is formed by the method of manufacturing a loading-type surveying sensor.

Details of other embodiments are included in detailed description of the invention” and the accompanying “drawings”.

The advantages and/or features of the present disclosure, and methods of achieving them will be clear by referring to the exemplary embodiments that will be describe hereafter in detail with reference to the accompanying drawings.

However, it should be noted that the present disclosure is not limited to the configuration of each of embodiments to be described hereafter and may be implemented in various ways, and the exemplary embodiments described in the specification are provided to complete the description of the present disclosure and let those skilled in the art completely know the scope of the present disclosure and the present disclosure is defined by claims.

According to the present disclosure, there is an effect of implementing a resistive antenna by spraying a carbon nanotube ink to a copper unclad substrate or implementing a resistive antenna by using a conductive polymer.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a view showing a resistive antenna using chip resistor soldering;

FIG. 2 is a view showing a discrete implementation process of a profile using a plurality of resistive pads according to an embodiment;

FIG. 3 is a view showing a discrete implementation process of a profile using a plurality of resistive pads according to another embodiment;

FIG. 4 is a view showing the configuration of a loading-type surveying sensor using a CNT or a conductive polymer according to an embodiment of the present disclosure; and

FIG. 5 is a flowchart showing the flow of a method of manufacturing a loading-type surveying sensor using a CNT or a conductive polymer according to an embodiment of the present disclosure.

### DETAILED DESCRIPTION

Before describing the present disclosure in detail, terms or words used herein should not be construed as being limited to common or dictionary meanings, the concepts of various terms may be appropriately defined to the most optimally describe the invention by the inventor (s), and it should be noted that those terms or words should be construed as meanings and concepts corresponding to the technical spirit of the present disclosure.

That is, it should be noted that the terms used herein are used only to describing preferred embodiments of the present disclosure, not intending to limit the present disclosure in detail, and those terms are terms defined in consideration of various possibilities of the present disclosure.

Further, it should be noted that, in the specification, singular expression may include plural expression unless clearly stated in the sentences, and includes a singular meaning even if it is similarly expressed as a plural number.

It should be noted that when a component is described another throughout as “including” component the specification, the component may further include another component without another component excluded, unless specifically stated otherwise.

Further, it should be noted that when a component is described as “exists in” and “is connected to” another component, the component may be directly connected with another component, may be installed in contact with another component, or may be installed with a predetermined gap. When the component is installed with a gap, there may be a third component or means for fixing and connecting the component to another component, and the third component or means may not be described.

On the other hands, it should be understood that when a component is described as “directly connected” or “indirectly connected” to another component, it should be construed as there is no third component or means.

Similarly, the terms used herein to describe a relationship between elements, that is, “between”, “directly between”, “adjacent” or “directly adjacent” should be interpreted in the same manner as those described above.

Further, in the specification, it should be noted that terms such as “first side”, “second side”, “first”, and “second”, if used, are used to clearly discriminate one components from another component and the meaning of the corresponding component is not limited by the terms.

Further, terms related to positions such as “up”, “down”, “left”, and “right”, if used herein, should be construed as indicating relative positions of corresponding components in the corresponding figures and should not be construed as stating absolute positions unless the absolute positions of them are specified.

Further, in the specification, when components are given reference numerals, the same reference numerals are given to same components even if they are shown in different figures, that is, same reference numerals indicate same components throughout the specification.

The size, position, coupling relationship, etc. of components of the present disclosure may be partially exaggerated or reduced in the accompanying drawings for the convenience of description in order to sufficiently and clearly transmit the spirit of the present disclosure, so the proportion or scale may not be precise.

Further, in the following description of the present disclosure, components that are determined to unclearly make the spirit of the present disclosure unclear, for example, well-known technology including the related art may not be described in detail.

Hereafter, embodiments of the present disclosure are described in detail with reference to relevant drawings.

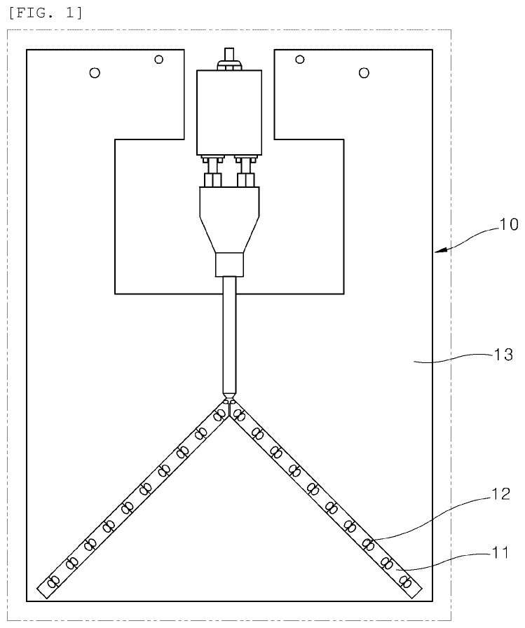

FIG. 1 is a view showing a resistive antenna using chip resistor soldering.

Referring to FIG. 1, a resistive antenna 10 using chip resistor soldering implements a discrete loading profile 11 using chip resistors 12.

In more detail, a copper pattern having a predetermined region is formed on a copper clad substrate 13 and a discrete resistor profile 11 is formed on the copper pattern.

The resistive antenna 10 using chip resistor soldering is formed by soldering chip resistors 12 to a predetermined region of the copper pattern.

When the resistive antenna 10 is manufactured using chip resistors, as described above, it is possible to adjust the size of resistors that are loaded in the antenna by adjusting the resistance value of the chip resistors 12.

In this case, the chip resistors 12 are easily separated from the antenna, so physical stability decreases and the accuracy of the profile is also limited.

Further, when the chip resistors 12 are used, the overall performance of the antenna is limited by the operating band of the chip resistors 12.

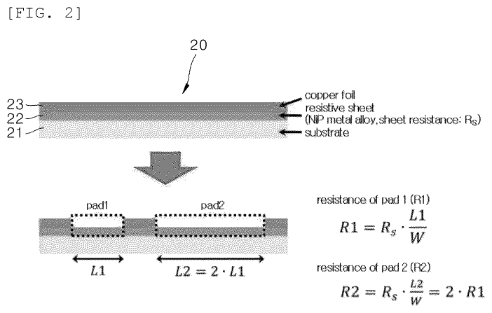

FIG. 2 is a view showing a discrete implementation process of a profile using a plurality of resistive pads according to an embodiment.

Referring to FIG. 2, a resistive sheet 22 having a sheet resistance value Rs is disposed on a substrate 21 and a metal layer such as a copper foil 23 is disposed on the resistive sheet 22.

When the resistive antenna 20 that is manufactured in this case is a resistive dipole antenna, the substrate 21 is exposed in all of regions excluding the dipole structure by etching of the resistive sheet 22 and the copper foil 23. Further, when the resistive antenna 20 is a resistive slot antenna, the substrate 21 is exposed only in the regions excluding resistive pads in the slot by etching of the resistive sheet 22 and the copper foil 23.

In this case, in order to form a discrete resistance profile, the metal layer (e.g., the copper foil 23) disposed on the resistive sheet 22 is removed through etching based on predetermined resistance magnitudes of resistive pads.

When the copper foil 23 is removed through etching, the resistive sheet 22 is exposed with predetermined lengths L1 and L2 at the etched portions and the exposed portions of the resistive sheet 22 become resistive pads of the resistive antenna 20.

In this case, the resistance magnitudes of the resistive pads are determined by the exposed shape and size of the resistive sheet 22. That is, when it is implemented in a rectangular shape, the resistance magnitude is determined by the length L1, L2 and the width W.

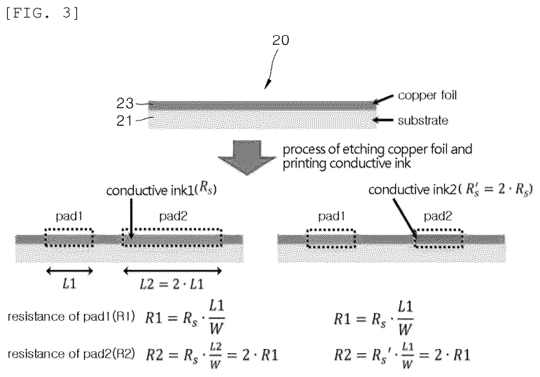

FIG. 3 is a view showing a discrete implementation process of a profile using a plurality of resistive pads according to another embodiment.

The components to be described with reference to FIG. 3 are the same as the components described with reference to FIG. 2.

Referring to FIG. 3, only a metal layer (e.g., a copper foil 23) is disposed on a substrate 21.

When the resistive antenna 20 that is manufactured in this case is a resistive dipole antenna, the substrate 21 is exposed in the resistive pad regions of dipole and all of regions excluding the dipole structure by etching of the copper foil 23. Further, when the resistive antenna 20 is a resistive slot antenna, the substrate 21 is exposed in all of regions in the slot by etching of the copper foil 23.

In particular, in order to form a discrete resistance profile, the copper foil 23 disposed on the substrate 21 is removed through etching based on predetermined resistance magnitudes of resistive pads.

In this case, a conductive substance (e.g., a conductive ink) is inserted or printed in the portions with the copper foil 23 removed, whereby resistive pads are formed.

In this case, the resistance magnitudes of the resistive pads may be determined by inserting the same kind of conductive substance (conductive ink 22) and making the shapes and sizes different.

That is, when it is a rectangular pad, the resistance magnitude may be determined by changing the length L1, L2 or the width W.

Further, the resistance magnitudes of the resistive pads may be determined by making the shapes of the portion in which the conductive substance 22 is inserted the same and making the kind of the conductive substance (conductive ink 22) different.

The resistive antenna 20 that is implemented in this way has the following characteristics.

Several sheet resistance pads are implemented through a printing technique, it is possible to implement the pads in the same shape and size, it is possible to adjust the detailed resistance values of the pads by adjusting the widths of the pads, and it is possible to print and manufacture desired pad portions through a printing process.

However, the chip resistor type or the resistive pad type according to FIGS. 1 to 3 described above both need etching of a predetermined antenna structure pattern on a copper clad substrate, so there is a problem that etching byproducts that are harmful to the environment are produced.

Accordingly, the preset disclosure provides a loading-type surveying sensor using a CNT or a conductive polymer that implements a resistive antenna by spraying a carbon nanotube ink on a copper unclad substrate or implements a resistive antenna by using a conductive polymer, and a method of manufacturing the loading-type surveying sensor.

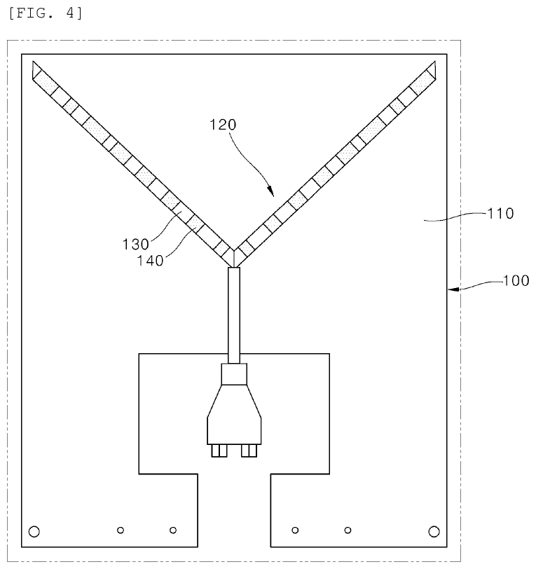

FIG. 4 is a view showing the configuration of a loading-type surveying sensor using a CNT or a conductive polymer according to an embodiment of the present disclosure.

Referring to FIG. 4, a loading-type surveying sensor 100 using a CNT or a conductive polymer according to the present disclosure includes a copper unclad substrate 11 and a profile 120.

A resistive antenna is an antenna loaded with a resistor in accordance with a certain profile 120 for a certain position in the antenna and has the advantage that it enables high density arrangement due to a small volume and the advantage that it can copy an ultra-wideband signal with little distortion in a time domain, so it can be generally used for short range imaging radars.

In the present disclosure, a resistive antenna may be a resistive dipole antenna.

The copper unclad substrate 110, which is a kind of Printed Circuit Boards (PCB) that are equipped with electronic parts using a surface mount technology of the related art and have been applied to various electronic products such as a mobile device, a computer, and a sound device, is applied to a resistive antenna in this embodiment, and it is possible manufacture a sensor in an environment-friendly manner because an etching process is not used in the present disclosure.

The profile 120 is formed on the copper unclad substrate 110.

A resistive dipole antenna of resistive antennas an antenna of a type formed by loading a resistor in a common dipole or a V dipole, a Wu-King profile may be used as the profile 120 of the resistor to be loaded, and other formulae or empirical profiles may also be applied.

The resistive profile of a resistive antenna provides information about a physical property of the antenna.

This is information about an electrical property of the resistive antenna and provides an impedance property in a specific frequency range.

The impedance of a resistive antenna is determined by electrical resistance, that is, inductance and capacitance that are generated between the antenna and a surrounding electric circuit.

The impedance of a resistive antenna depends on the electric waves and the frequency generated by the antenna and may be generated in various types, depending on the design and components of the resistive antenna.

Accordingly, designers of a resistive antenna can adjust and optimize the resistive antenna such that the antenna can show optimal electrical performance within a desired frequency range.

Further, the Wu-King profile is a representative example of an antennal loading technique that removes a resonance mode and generates an anti-reflective traveling-wave mode in the field of designing of antennas.

The Wu-King profile is a nonlinear resistive graph generally composed of a plurality of periods for the length of an antenna.

This graph shows a resistance value per unit length that is loaded in an antenna and is optimized to maximize power migration between the antenna and a transceiver.

The Wu-King profile is generally used in the field of designing of antennas and is used in antenna types and frequency ranges for various short range radars.

In order to implement the profile 120, an antenna region is divided into a plurality of sections with predetermined intervals and then resistive substances 140 having specific shapes, sizes, and resistance values are formed for the sections, respectively.

In resistive antennas, a resistive substance 140 is a material that determines the electrical property of the resistive antennas.

Such a resistive substance 140 serves to adjust the impedance of resistive antennas and influences the electrical property of resistive antennas, so it plays an important role in the performance of resistive antennas. Accordingly, a substance having high resistance is generally used as a resistive substance 140 that is used in resistive antennas.

Accordingly, such a substance serves to control the electrical property of resistive antennas and adjust the impedance of resistive antennas.

Selection of a resistive substance 140 depends on the designing purpose and the application environment of resistive antennas.

In order to optimize the performance of resistive antennas, it is important to select an appropriate resistive substance 140 and designers of resistive antennas should consider the properties of various resistive substances 140 and select a substance that is the most suitable for the purposes and application environments of resistive antennas.

In this embodiment, a carbon nanotube (CNT) ink may be used as the resistive substance 140.

A carbon nanotube ink is a nanotube ink produced using a carbon nanotube and is applied in various fields such as electronic engineering, a nano technology, bio sensors, and solar cells.

A carbon nanotube has a structure in which carbon atoms are arranged in a hexagonal shape and the length thereof is various from several nanometers to hundreds of nanometers.

When an ink is produced and used using such a carbon nanotube, the electrical and mechanical properties are excellent, so the ink can be used in various fields.

For example, in the field of electronic engineering, a carbon nanotube ink can be used to manufacture circuit patterns, wireless antennas, and ultra high frequency elements.

Further, in the field of bio sensor, it is possible to manufacture sensors based on a carbon nanotube and use the sensors for detection and diagnosis of molecules in organisms.

In the field of solar cell, it may be possible to increase the efficiency of solar cells using a carbon nanotube.

A carbon nanotube ink is currently being studied and developed in various ways and is expected to be applied in more various fields.

In this embodiment, for the region inside an antenna, a carbon nanotube ink that is a resistive substance 140 is formed, thereby implementing resistive loading.

Further, in this embodiment, a conductive polymer ink may also be used as the resistive substance 140.

A conductive polymer ink is one of materials that can be used to manufacture resistive antennas in the field of designing and manufacturing antennas.

A conductive polymer, which is a macromolecule-based resistive substance 140, is a substance having electrical conductivity, and as a representative example, there is a PEDOT: PSS structure.

Such a conducive polymer, which is a material that is used to adjust a loading profile of resistive antennas, is very effective, light, and flexible and provides designers of resistive antennas with various advantages such as high anticorrosion.

Designers of resistive antennas should optimize electrical properties such as impedance, frequency selection, and radiation pattern of resistive antennas in consideration of the properties of a conductive polymer.

Meanwhile, in the loading-type surveying sensor 100 according to the present disclosure, the resistive substance 140 may be formed by a spray coating method.

Preferably, a carbon nanotube ink or a conductive polymer may be formed by a spray coating method.

Spray coating is the process of coating solid particles or liquid materials onto a corrosive or thermoplastic surface.

Spray coating is generally used in various industrial fields and can improve anticorrosion, durability, electrical properties, etc. of coated products or can provide additional functions.

Various techniques are used as spray coating, and there are oxidized zinc spray coating, oxidized aluminum spray coating, plasma spray coating, chemical deposition, thermal deposition, etc. as the most general techniques.

Such techniques are selected in accordance with the kind, anticorrosion, or performance requests such as thermoplasticity of solid particles or liquid substances that are coated on thermoplastic surfaces.

Spray coating, which is a simplest and effective method, can improve durability of parts and can provide additional functions such as anticorrosion or thermoplasticity, and for this reason, spray coating is used in various industrial fields such as the aerospace industry, the automotive industry, and the petrochemical industry.

For example, in this embodiment, it is possible to make a carbon nanotube ink or a conductive polymer, which is an application solution, in a mist type (mist) and apply it to a plurality of regions.

As such spray coating is recently advanced and diversified, spray coating is used for wide uses from coating of thin films of single sheets such the transparent conductive film of a touch panel to applying of materials of solar cells and a photoresist of semiconductors.

As such a spray coating type, there are an air spray coating method, an ultrasonic spray coating method, and an electrostatic spray coating method, etc.

The air spray coating method is a method of making a carbon nanotube ink or a conductive polymer, which is an application solution, into fine a mist type using compressed air and of spraying it to a plurality of regions.

A carbon nanotube ink or a conductive polymer that is an application solution and is discharged from a nozzle by compressed air is under high pressure, so it hits against static air at a high speed.

In this case, the carbon nanotube ink or the conductive polymer that is an application solution becomes a mist type while being dissolved and slowed down by resistance of the air, and reaches a plurality of regions.

The air spray coating method scatters a large amount of carbon nanotube ink or conductive polymer that is an applying solution, so the material may be relatively easily lost.

In order to prevent this problem, it may be possible to uniformly apply a carbon nanotube ink or a conductive polymer that is an applying solution to fine uneven surfaces of a plurality of regions using a nozzle that makes the carbon nanotube ink or the conductive polymer into fine particles or to enable stable spraying while maintaining high-speed spraying.

Further, an ultrasonic spray has a chip (atomized surface) at a nozzle end.

When an ultrasonic wave vibrates, an applying solution spreads to the chip and starts to wave.

Further, when an ultrasonic wave is output until surface tension is exceeded, the applying solution becomes mist-type droplets and flies.

Since the droplets are fine and uniform, they are suitable for local and uniform application.

Further, there is little waste due to flying or scattering of droplets, so there is the advantage that a loss of material is very small.

A nozzle is selected from various lengths, sizes, and shapes in accordance with the purpose, a necessary flow rate or frequency of vibration is set, and it is possible to control the thickness of a coating film or the quality of a film by uniformly spraying droplets.

According to the electrostatic spray (electro spray) coating method, an application solution is electrified by thousands of volts in a nozzle and becomes a fin mist (mist type) due to repulsive force by electrification.

The application solution that became a mist is attracted and attached to the surfaces of a plurality of regions on an earthed stage.

It is possible to form a uniform film even on materials that correspond to liquid having various levels of viscosity or liquid containing distribution of pastes, slurries, and fillers and have an uneven surface.

Further, it is possible to attach most of liquid only to the surfaces of a plurality of regions, so the efficiency of using liquid is very high and it is possible to reduce the material cost in comparison to common air spray coater and spin coater.

Meanwhile, in the loading-type surveying sensor 100 according to the present disclosure, the resistive substance 140 may be formed by a screen printing method.

Screen printing, which is one of printing methods, is a technique of printing a graphic design onto various types of material.

This method can be manually performed, but automated machines are used for mass production.

Screen printing can print a graphic design onto various materials such as paper, a board, metal, glass, a fiber, etc., provides high printing resolution and texture, and can deal with even large-area printing materials.

As the operation principle of screen printing, first, a screen including a design to be printed is manufactured.

The screen functions as a kind of template and the region to be printed is composed of a mesh with small holes.

Thereafter, ink or paint is put on the upper end of the screen and the screen is put on the surface of a material.

When the ink is transmitted to the material through the mesh of the screen by pushing the ink at the lower end of the screen, the graphic design printed on the screen shows up on the material.

The screen printing method is relatively simple in comparison to other printing methods, can be applied to various materials, and provides high printing resolution and texture, so it can make various designs.

Meanwhile, in the loading-type surveying sensor 100 according to the present disclosure, the resistive substance 140 may be formed by an inkjet printing method.

Inkjet printing, which is a technique of making desired patterns by spraying ink from a printing head, has the advantages of high precision, low cost, high production speed, etc. in comparison to existing printing techniques.

In manufacturing of a resistive antenna according to this embodiment, it is possible to quickly and precisely print a resistive material or a conductive material with specific patterns using inkjet printing.

Accordingly, it is possible to make a resistance pattern, etc. of a resistive antenna and manufacturing of a resistive antenna is finished through appropriate post-processing such that a printed material is sufficiently brought into contact.

Further, in the loading-type surveying sensor 100 according to the present disclosure, a conductive substance 130 may be formed between a plurality of regions.

The conductive substance 130, which is a substance having electrical conductivity, means a substance through which electricity can freely move.

The conductive substance 130 can enable electricity to flow and can be used in various fields such as an electric circuit, an electric part, and an electrolyte.

The conductive substance 130 is classified into metal, a semiconductor, an electrolyte, etc., and metal, which is a substance having high electrical conductivity, has free electrons that can make electricity flow.

A semiconductor, which is a substance having low electrical conductivity, transmits electricity using electrons or protons and electrons to fill electron vacancies, and an electrolyte, which is a substance transmitting electricity using movement of ions, transmits electricity in a dissolve or molten state of the substance.

In resistive antennas, a conductive substance 130 serves to receive or transmit electromagnetic signals of the resistive antennas.

In resistive antennas, a conductive substance 130 such as a metal or silver ink may be used.

For example, in this embodiment, the conductive substance 130 may be a silver ink.

A silver ink is a conductive material made using silver nano-particles.

That is, it is possible to use a silver ink for transmission of electrical signals of antennas by appropriately spraying or printing the silver ink to an electrical signal transmission path of antennas.

A silver ink has excellent electrical conductivity and a stable electrical property, so it improves the electrical performance of antennas.

For example, the electrical conductivity of a silver ink is close to 0Ω, so its resistance is low and the electrical conductivity is very similar to the electrical conductivity of a copper foil.

Further, the manufacturing method such as spraying or printing is simple and the cost is efficient, so a silver ink can be produced in large quantities.

For this reason, a silver ink can play a very important role in the field of manufacturing electronic devices such as a resistive antenna.

Further, in the loading-type surveying sensor 100 according to the present disclosure, the conductive substance 130 may be formed by a screen printing method.

Such screen printing, which is one of printing methods, is a technique of printing a graphic design onto various types of material.

This method can be manually performed, but automated machines are used for mass production.

Screen printing can print a graphic design onto various materials such as paper, a board, metal, glass, a fiber, etc., provides high printing resolution and texture, and can deal with even large-area printing materials.

As the operation principle of screen printing, first, a screen including a design to be printed is manufactured.

The screen functions as a kind of template and the region to be printed is composed of a mesh with small holes.

Thereafter, ink or paint is put on the upper end of the screen and the screen is put on the surface of a material.

When the ink is transmitted to the material through the mesh of the screen by pushing the ink at the lower end of the screen, the graphic design printed on the screen shows up on the material.

The screen printing method is relatively simple in comparison to other printing methods, can be applied to various materials, and provides high printing resolution and texture, so it can make various designs.

Further, in the loading-type surveying sensor 100 according to the present disclosure, the conductive substance 130 may be formed by an inkjet printing method.

Inkjet printing, which is a technique of making desired patterns by spraying ink from a printing head, has the advantages of high precision, low cost, high production speed, etc. in comparison to existing printing techniques.

In manufacturing of a resistive antenna according to this embodiment, it is possible to quickly and precisely print a resistive material or a conductive material with specific patterns using inkjet printing.

Accordingly, it is possible to make a metal pattern, a resistance pattern, etc. of a resistive antenna and manufacturing of a resistive antenna is finished through appropriate post-processing such that a printed material is sufficiently brought into contact.

Inkjet printing can use various kinds of ink, so it has the advantage of a large selection width of the materials of resistive antennas.

For example, it is possible to make resistive antennas using a printing ink containing various materials such as silver nano-particles, a carbon nanotube, and a metal filler.

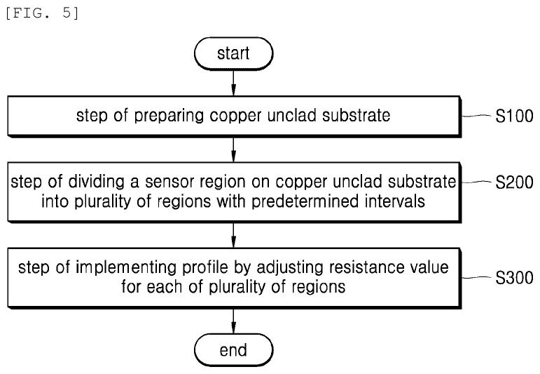

FIG. 5 is a flowchart showing the flow of a method of manufacturing a loading-type surveying sensor using a CNT or a conductive polymer according to an embodiment of the present disclosure.

The loading-type surveying sensor 100 according to the present disclosure described above can be formed by a method of manufacturing a loading-type surveying sensor to be described below.

Referring to FIG. 5, a method of manufacturing a loading-type surveying sensor according to the present disclosure may include three steps.

In a first step S100, a copper unclad substrate 110 is prepared.

In a second step S200, an antenna region on the copper unclad substrate 110 is divided into a plurality of sections composed of conductive regions and resistive regions with predetermined gaps.

In a third step S300, a profile 120 is implemented by adjusting the shapes, sizes, and resistance values of the conductive regions and the resistive regions for the separated sections.

Such copper unclad substrate 110 and profile 120 were sufficiently described with reference to FIG. 4, so detailed description thereof is omitted.

Further, in the method of manufacturing a loading-type surveying sensor 100 according to the present disclosure, a resistive substance 140 may be formed in a plurality of regions.

In resistive antennas, a resistive substance 140 is a material that determines the electrical property of the resistive antennas.

Such a resistive substance 140 serves to adjust the impedance of resistive antennas and influences the electrical property of resistive antennas, so it plays an important role in the performance of resistive antennas.

Accordingly, a substance having high resistance is generally used as a resistive substance 140 that is used in resistive antennas.

Accordingly, such a substance serves to control the electrical property of resistive antennas and adjust the impedance of resistive antennas.

Selection of a resistive substance 140 depends on the designing purpose and the application environment of resistive antennas.

In order to optimize the performance of resistive antennas, it is important to select an appropriate resistive substance 140 and designers of resistive antennas should consider the properties of various resistive substances 140 and select a substance that is the most suitable for the purposes and application environments of resistive antennas.

Further, in the method of manufacturing a loading-type surveying sensor 100 according to the present disclosure, a resistive substance 140 may be a carbon nanotube ink or a conductive polymer.

In this embodiment, it is possible to form a resistive profile by forming a carbon nanotube ink that is a resistive substance 140 in a plurality of regions formed in the profile 120 or to form a resistive profile by forming a conductive polymer using the resistive substance 140.

Further, the resistive substance 140 may be formed by a spray coating method.

Preferably, a carbon nanotube ink or a conductive polymer may be formed by a spray coating method.

Spray coating is the process of coating solid particles or liquid materials onto a corrosive or thermoplastic surface.

Spray coating is generally used in various industrial fields and can improve anticorrosion, durability, electrical properties, etc. of coated products or can provide additional functions.

Various techniques are used as spray coating, and there are oxidized zinc spray coating, oxidized aluminum spray coating, plasma spray coating, chemical deposition, thermal deposition, etc. as the most general techniques.

Such techniques are selected in accordance with the kind, anticorrosion, or performance requests such as thermoplasticity of solid particles or liquid substances that are coated on thermoplastic surfaces.

Spray coating, which is a simplest and effective method, can improve durability of parts and can provide additional functions as anticorrosion or such thermoplasticity, and for this reason, spray coating is used in various industrial fields such as the aerospace industry, the automotive industry, and the petrochemical industry.

Further, in the method of manufacturing a loading-type surveying sensor 100 according to the present disclosure, a resistive substance 140 may be formed by a screen printing method.

Screen printing, which is one of printing methods, is a technique of printing a graphic design onto various types of material.

This method can be manually performed, but automated machines are used for mass production.

Screen printing can print a graphic design onto various materials such as paper, a board, metal, glass, a fiber, etc., provides high printing resolution and texture, and can deal with even large-area printing materials.

As the operation principle of screen printing, first, a screen including a design to be printed is manufactured.

The screen functions as a kind of template and the region to be printed is composed of a mesh with small holes.

Thereafter, ink or paint is put on the upper end of the screen and the screen is put on the surface of a material.

When the ink is transmitted to the material through the mesh of the screen by pushing the ink at the lower end of the screen, the graphic design printed on the screen shows up on the material.

The screen printing method is relatively simple in comparison to other printing methods, can be applied to various materials, and provides high printing resolution and texture, so it can make various designs.

Meanwhile, in method of manufacturing a loading-type surveying sensor 100 according to the present disclosure, a resistive substance 140 may be formed by an inkjet printing method.

Inkjet printing, which is a technique of making desired patterns by spraying ink from a printing head, has the advantages of high precision, low cost, high production speed, etc. in comparison to existing printing techniques.

In manufacturing of a resistive antenna according to this embodiment, it is possible to quickly and precisely print a resistive material or a conductive material with specific patterns using inkjet printing.

Accordingly, it is possible to make a resistance pattern, etc. of a resistive antenna and manufacturing of a resistive antenna is finished through appropriate post-processing such that a printed material is sufficiently brought into contact.

Meanwhile, in the method of manufacturing a loading-type surveying sensor 100 according to the present disclosure, a conductive substance 130 may be formed between a plurality of regions.

In this embodiment, the conductive substance 130 may be a silver ink.

A silver ink is a conductive material made using silver nano-particles.

Silver nano-particles are metal having high electrical conductivity and have high reflectivity and stability, so they are suitable for transmission of electrical signals in resistive antennas.

A silver ink can be easily applied to antennas or other electronic devices through spraying, printing, or the like.

That is, it is possible to use a silver ink for transmission of electrical signals of antennas by appropriately spraying or printing the silver ink to an electrical signal transmission path of antennas.

A silver ink has excellent electrical conductivity and a stable electrical property, so it improves the electrical performance of antennas.

Further, the manufacturing method such as spraying or printing is simple and the cost is efficient, so a silver ink can be produced in large quantities.

For this reason, a carbon nanotube silver ink can play a very important role in the field of manufacturing electronic devices such as a resistive antenna.

Further, in the method of manufacturing a loading-type surveying sensor 100 according to the present disclosure, a conductive substance 130 may be formed by a screen printing method.

Screen printing, which is one of printing methods, is a technique of printing a graphic design onto various types of material.

This method can be manually performed, but automated machines are used for mass production.

Screen printing can print a graphic design onto various materials such as paper, a board, metal, glass, a fiber, etc., provides high printing resolution and texture, and can deal with even large-area printing materials.

As the operation principle of screen printing, first, a screen including a design to be printed is manufactured.

The screen functions as a kind of template and the region to be printed is composed of a mesh with small holes.

Thereafter, ink or paint is put on the upper end of the screen and the screen is put on the surface of a material.

When the ink is transmitted to the material through the mesh of the screen by pushing the ink at the lower end of the screen, the graphic design printed on the screen shows up on the material.

The screen printing method is relatively simple in comparison to other printing methods, can be applied to various materials, and provides high printing resolution and texture, so it can make various designs.

Further, in the method of manufacturing a loading-type surveying sensor 100 according to the present disclosure, a conductive substance 130 may be formed by a inkjet printing method.

Inkjet printing, which is a technique of making desired patterns by spraying ink from a printing head, has the advantages of high precision, low cost, high production speed, etc. in comparison to existing printing techniques.

In manufacturing of a resistive antenna according to this embodiment, it is possible to quickly and precisely print a resistive material or a conductive material with specific patterns using inkjet printing.

Accordingly, it is possible to make a metal pattern, a resistance pattern, etc. of a resistive antenna and manufacturing of a resistive antenna is finished through appropriate post-processing such that a printed material is sufficiently brought into contact.

Inkjet printing can use various kinds of ink, so it has the advantage of a large selection width of the materials of resistive antennas.

For example, it is possible to make resistive antennas using a printing ink containing various materials such as silver nano-particles, a carbon nanotube, and a metal filler.

Meanwhile, in the loading-type surveying sensor 100 according to the present disclosure and the manufacturing method thereof, the resistive antenna 100 is implemented by a resistive substance 140 having signal sheet resistance and it is possible to change the resistance value of the resistive substance 140 by adjusting the widths of a plurality of regions for forming the resistive substance 140.

A resistance value of the resistive substance 140 according to the sheet resistance RS of the resistive substance 140, the length L of the resistive substance 140, and the width W of the resistive substance 140 is as the following equation 1.

$$R = {R}_{S} \cdot L / W \qquad [ Equation 1 ]$$

where R is the resistance value of the resistive substance 140, Rs is the sheet resistance value of the resistive substance 140, L is the length of the resistive substance 140, and W is the width of the resistive substance 140.

It may be possible to adjust the lengths of a plurality of regions on the basis of predetermined magnitudes of resistance of the resistive substances 140 or to determine the magnitudes of the resistance of the resistive substances 140 by making the lengths of a plurality of regions the same and making the kinds of the resistance substance 140 different from each other.

As described above, according to the present disclosure, there is an effect of implementing a resistive antenna by spraying a carbon nanotube ink to a copper unclad substrate or implementing a resistive antenna by using a conductive polymer.

Various preferred embodiments of the present disclosure were described above through some examples, but the various embodiments described in “detailed description of the invention” are only examples and it would be clearly understood by those skilled in the art the present disclosure may be changed in various ways or equivalently implemented from the above description.

Further, it should be noted that since the present disclosure may be implemented in other various ways, the present disclosure is not limited to the above description, the above description is provided to completely explain the present disclosure and provided only to completely inform those skilled in the art of the range of the present disclosure, and the present disclosure is defined by only claims.

What is claimed is:

1. A loading-type surveying sensor comprising:
a copper unclad substrate; and
a conductive region and a resistive region formed on the copper unclad substrate,
wherein the conductive region and the resistive region are formed in a plurality of regions in accordance with predetermined shape and resistance value.

2. The loading-type surveying sensor of claim 1, wherein a resistive substance is formed in the resistive region.

3. The loading-type surveying sensor of claim 2, wherein the resistive substance is a carbon nanotube (CNT) ink or a conductive polymer.

4. The loading-type surveying sensor of claim 2, wherein the resistive substance is formed by a spray coating method.

5. The loading-type surveying sensor of claim 2, wherein the resistive substance is formed by a screen printing method.

6. The loading-type surveying sensor of claim 2, wherein the resistive substance is formed by an inkjet printing method.

7. The loading-type surveying sensor of claim 1, wherein a conductive substance is formed in the conductive region.

8. The loading-type surveying sensor of claim 7, wherein the conductive substance is a silver ink.

9. The loading-type surveying sensor of claim 7, wherein the conductive substance is formed by a screen printing method.

10. The loading-type surveying sensor of claim 7, wherein the conductive substance is formed by an inkjet printing method.

11. A method of manufacturing a loading-type surveying sensor, the method comprising:
preparing a copper unclad substrate;
dividing a sensor region into a plurality of regions with predetermined intervals on the copper unclad substrate; and
implementing a profile by forming a resistance value for each of the plurality of separated regions.

12. The method of claim 11, wherein a resistive substance is formed in the plurality of regions.

13. The method of claim 12, wherein the resistive substance is a carbon nanotube (CNT) ink or a conductive polymer.

14. The method of claim 12, wherein the resistive substance is formed by a spray coating method.

15. The method of claim 12, wherein the resistive substance is formed by a screen printing method.

16. The method of claim 12, wherein a conductive substance is formed between the plurality of regions.

17. The method of claim 16, wherein the conductive substance is a silver ink.

18. The method of claim 16, wherein the conductive substance is formed by a screen printing method.

19. The method of claim 16, wherein the conductive substance is formed by an inkjet printing method.

20. A loading-type surveying sensor formed by the method of manufacturing a loading-type surveying sensor of claim 11.
